(19) United States
(12) Patent Application Publication
(10) Pub. No.: US 2026/0179800 A1
(43) Pub. Date: Jun. 25, 2026

(54) System for Transportation of Highly Enriched Uranium Hexafluoride

(71) Applicant: NAC International Inc., Norcross, GA (US)

(72) Inventors: Steve Sisley, Peachtree Corners, GA (US); Jack Boshoven, Dacula, GA (US); Juan Subiry, Atlanta, GA (US)

(21) Appl. No.: 19/424,254

(22) Filed: Dec. 18, 2025

Related U.S. Application Data
(60) Provisional application No. 63/736,076, filed on Dec. 19, 2024.

(51) Int. Cl. G21F 5/12; G21F 5/015

(52) U.S. Cl. CPC G21F 5/12; G21F 5/015

(57) ABSTRACT

A container for storing high assay low enriched uranium hexafluoride (UF6) has a cylindrical lateral wall extending between first and second heads defining a container interior for receiving the radioactive material. A plurality of cylindrical poison rods extend in parallel through the container interior. Each of the poison rods has a neutron absorber. A plurality of access nozzles are situated within the first head and/or second head. Each of the access nozzles has a lateral wall defining a throughway that extends through the first head between an interior end region and an exterior end region. The interior end region captures and supports a respective end of a respective poison rod. The exterior end region is opened and closed via respectively detaching and attaching an end cap to thereby respectively expose and contain the respective poison rod.

### CLAIM OF PRIORITY

This application claims priority to and the benefit of provisional application No. 63/736,076 filed Dec. 19, 2024, which is incorporated herein by reference in its entirety.

### BACKGROUND OF THE INVENTION

A UF6 30B cylinder is a specialized container used for the storage and transport of uranium hexafluoride (UF6), which is a compound used in the uranium enrichment process. Key features of a standard UF6 30B cylinder are as follows:
Material: The cylinder is made of carbon steel, providing durability
Dimensions: It has a diameter of 30 inches, hence the name “30B”.
Capacity: The cylinder can hold a significant amount of UF6, typically up to 2.27 metric tons with an enrichment up to 5 wt. % U235.
Design: It is a right circular cylinder, often transported in an overpack for additional protection against mechanical and thermal impacts during transit.
Safety: The design adheres to international standards such as ISO 7195 and ANSI N14.1, ensuring safety during handling and transport.

FIG. 1 provides an illustration of an existing 30B cylinder 15. These cylinders 15 are crucial in the nuclear fuel cycle, particularly in the enrichment and fuel fabrication stages. Unfortunately, these cylinders 15 can only accommodate enriched uranium UF6 up to and enrichment of 5% U235

High-Assay Low-Enriched Uranium (HALEU) is uranium that has been enriched to have a concentration of the fissile isotope uranium-235 (U-235) between 5% and 20%. This is higher than the 3% to 5% U-235 concentration found in the Low-Enriched Uranium (LEU) used in most current nuclear reactors.

HALEU is crucial for several reasons, as follows:
Advanced Nuclear Reactors: Many new reactor designs, including small modular reactors (SMRs) and other advanced reactors, require HALEU to achieve higher efficiency, longer operating cycles, and better fuel utilization.
Medical Isotopes: HALEU is used to produce medical isotopes, which are essential for various diagnostic and therapeutic procedures.
Research and Test Reactors: Some research and test reactors use HALEU to achieve the necessary performance and safety standards.

The development and deployment of advanced nuclear technologies heavily depend on the availability of HALEU, making it a key component in the future of nuclear energy. HALEU is being produced at enrichment facilities producing UF6 enriched up to 20% concentration. For this reason, there is a need for a high capacity UF6 cylinder package, like a standard 30B cylinder 15 (i.e, objective to leverage existing handling and processing infrastructure), but that accommodates higher enrichments. The main challenge to accommodate HALEU materials with its higher enrichment in a 30B cylinder 15 is criticality control. Several concepts have been developed that try to adapt existing 30B designs by introducing burnable poison rod materials inside the cylinder 15 to provide means for neutron absorption and maintain a fully loaded cylinder 15 in subcritical state. FIG. 2 shows the internal basket structure 16 for securing internal poison rods 17 in a modified 30B cylinder 15 that can be used for UF6 with higher enrichments. The rods 17 are often solid neutron absorbers. Although this approach addresses the need for criticality control, there are a number of issues associated with having poison material and basket structure 16 encased inside the cylinder. The following are known potential issues:
Inspection of the poison rods 17 requires complex endoscopy methods to inspect rod system inside the cylinder 15.
Potential dislodgement or movement of poison rods 17 will be practically undetected (in other words, rods are inside the cylinder 15 and a change in configuration will not be visible)
Lack of access to repair or replace rods 17.

Internal basket structure 16 interferes with UF6 gas flow and creates temperature gradients which may cause issues with solidification of material and potential obstructions. There are no mechanisms to control the temperature of the basket 16.

Fabrication and construction of cylinder internals are more complex.

### SUMMARY OF THE INVENTION

The present disclosure provides various embodiments of a container and method for storing and/or transporting radioactive material, particularly but not limited to, high assay low enriched uranium hexafluoride (HALEU), which has a concentration of the fissile isotope uranium-235 (U-235) between 5% and 20%.

One embodiment, among others, is a container having a cylindrical lateral wall extending between concave first and second heads to define a container interior for receiving the radioactive material. A plurality of cylindrical poison rods extend in parallel through the container interior. Each of the poison rods contains a neutron absorber. A plurality of access nozzles are situated within the first head and/or the second head. Each of the access nozzles has a lateral wall defining a throughway that extends through the first head between an interior end region and an exterior end region. The interior end region captures and supports a respective end of a respective poison rod. The exterior end region is opened and closed via respectively detaching and attaching an end cap to thereby respectively expose and contain the respective poison rod.

Another embodiment, among others, is a method for storing radioactive uranium hexafluoride (HF6), which can be summarized by the following steps: providing a container as described in the previous paragraph and containing the UF6; detaching an end cap of at least one of the access nozzles to expose a respective poison rod; removing the respective poison rod; inserting a new poison rod into the container to replace the respective poison rod by way of the respective access nozzle; and attaching the end cap to the at least one access nozzle in order to contain the new poison rod.

Other embodiments, apparatus, systems, methods, features, and advantages of the present invention will be apparent to one with skill in the art upon examination of the following drawings and detailed description. It is intended that all such additional embodiments, apparatus, methods, features, and advantages be included within this disclosure, be within the scope of the present invention, and be protected by the accompanying claims.

### BRIEF DESCRIPTION OF THE DRAWINGS

Many aspects of the disclosure can be better understood with reference to the accompanying drawings. The components in the drawings are not necessarily to scale, emphasis instead being placed upon clearly illustrating the principles of the present disclosure.

FIG. 1 shows an existing 30B cylinder.

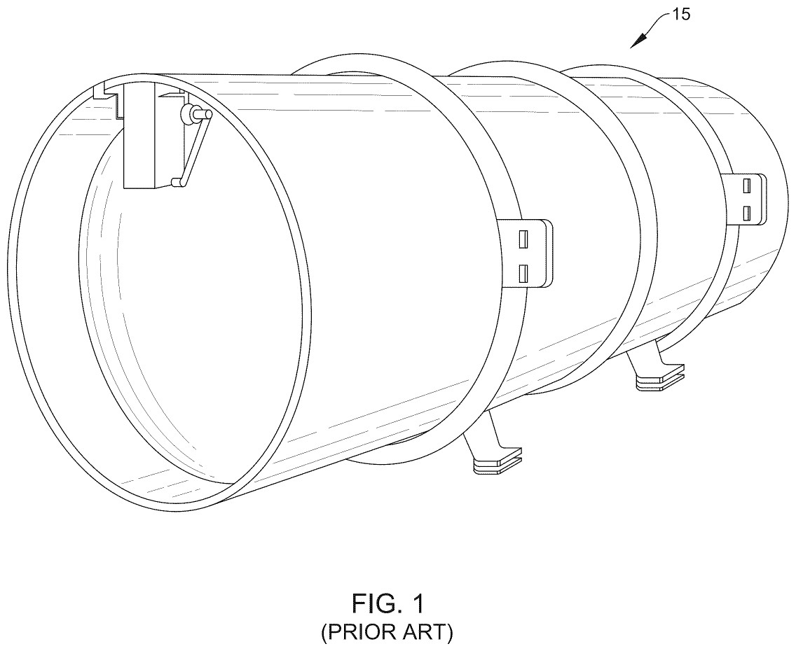

FIG. 2 shows the existing 30B cylinder of FIG. 1 with partial cutaway showing another method to provide criticality control for HALEU UF6 with its internal poison rod basket structure.

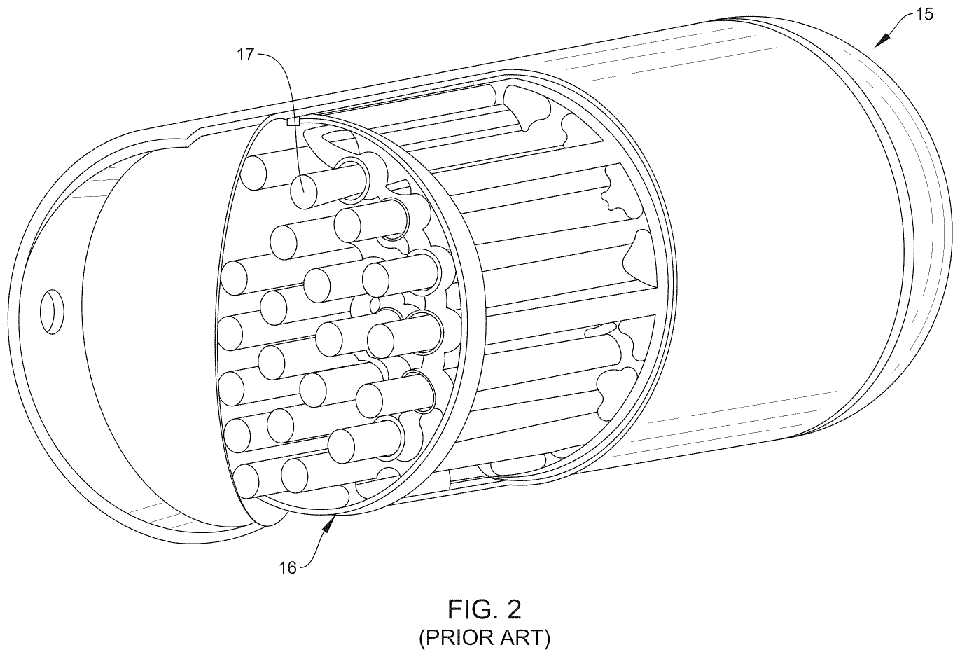

FIG. 3 shows the container of the present disclosure for storing and transporting radioactive material, particularly but not limited to, high assay low enriched uranium hexafluoride (HALEU), which has a concentration of the fissile isotope uranium-235 (U-235) between 5% and 20%.

FIG. 4 shows the container of FIG. 3 with a plurality of poison rods ready to be loaded.

FIG. 5 shows an end view of the container of FIG. 3 without the poison rods inserted.

FIG. 6 shows an end view of the container of FIG. 3 with the poison rods installed inside the container.

FIG. 7 shows a plurality of end caps before installation on the container of FIG. 3.

FIG. 8 shows a side cross sectional view of an embodiment of the fully assembled container of FIG. 3 with poison rod tubes containing a neutron absorbing material.

### DETAILED DESCRIPTION OF THE PREFERRED EMBODIMENT(S)

The present disclosure provides various embodiments of a container (or cylinder) and method for storing radioactive material, particularly but not limited to, high assay low enriched uranium hexafluoride (HALEU), which has a concentration of the fissile isotope uranium-235 (U-235) between 5% and 20%. The container incorporates multiple removable poison rods arranged axially and distributed uniformly according to an optimized pattern for criticality control. These poison rods are inserted or removed through the full length of the container and are secured by removable end caps situated over access nozzles at one or both ends of the container. The access nozzles are welded to the container's heads, ensuring the container maintains both containment and confinement.

The innovative design features removable rods, allowing for easy inspection, easy replacement of poison rods showing any signs of degradation, and maintenance. This accessibility also facilitates the integration of heating or cooling systems to ensure uniform cylinder temperature. Additionally, the access nozzles are welded to the cylinder head and bottom heads, making weld inspections straightforward.

The container offers several technical features and benefits that are not readily apparent from prior art. The operational concepts and cylinder design are unique to this container and do not explicitly outline a method of operation that differs significantly from current practices. In summary, the design allows for the operation of UF6 cylinders for HALEU in a manner similar to their use in the LEU fuel cycle.

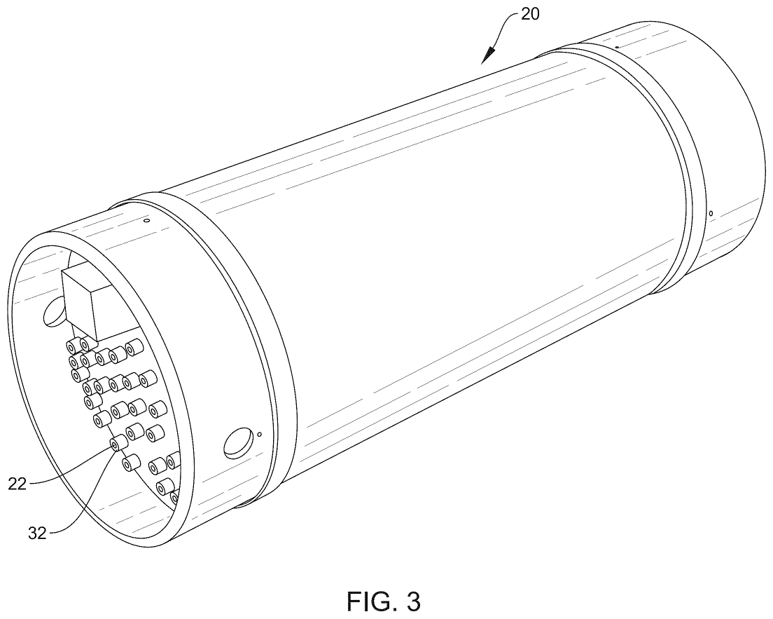

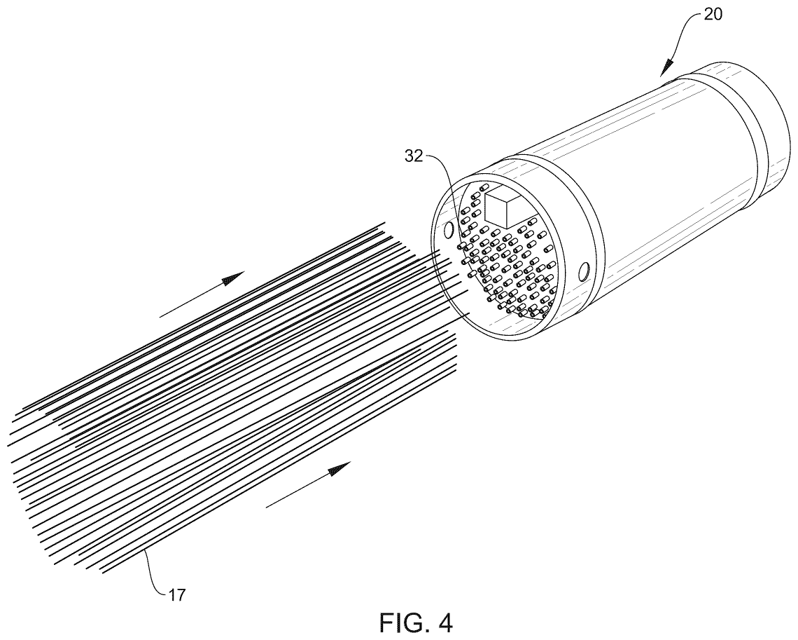

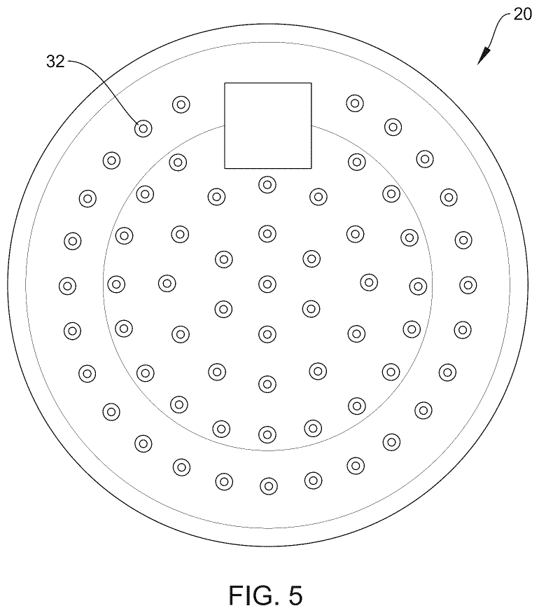

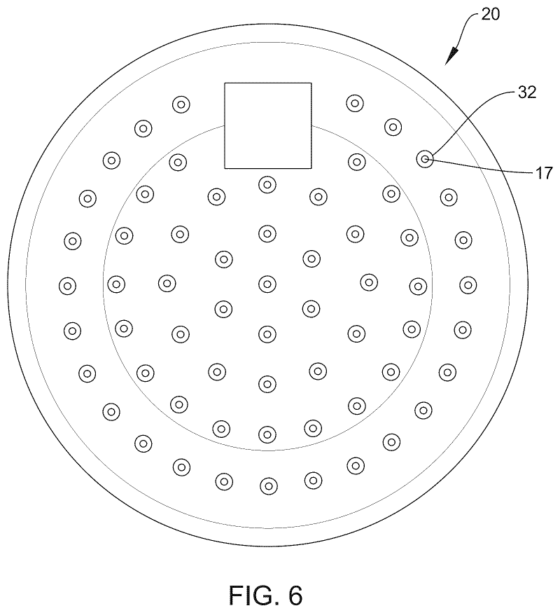

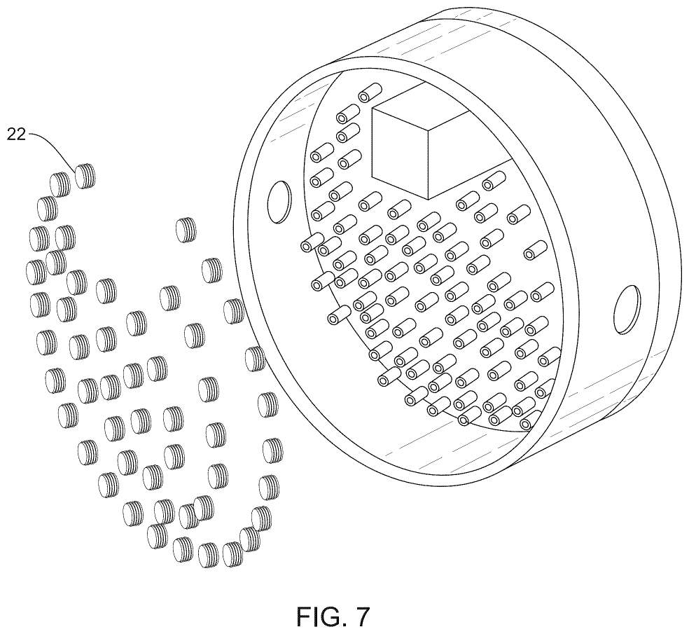

FIG. 3 shows the container 20 of the present disclosure. FIG. 4 shows the container 20 with a plurality of poison rods 17 ready to be loaded. FIG. 5 shows an end view of the container 20 without the poison rods 17 inserted into respective access nozzles 32. FIG. 6 shows an end view of the container 20 with the poison rods 17 installed inside the container 20 through respective access nozzles 32. FIG. 7 shows a plurality of end caps 22 before installation on the container 20.

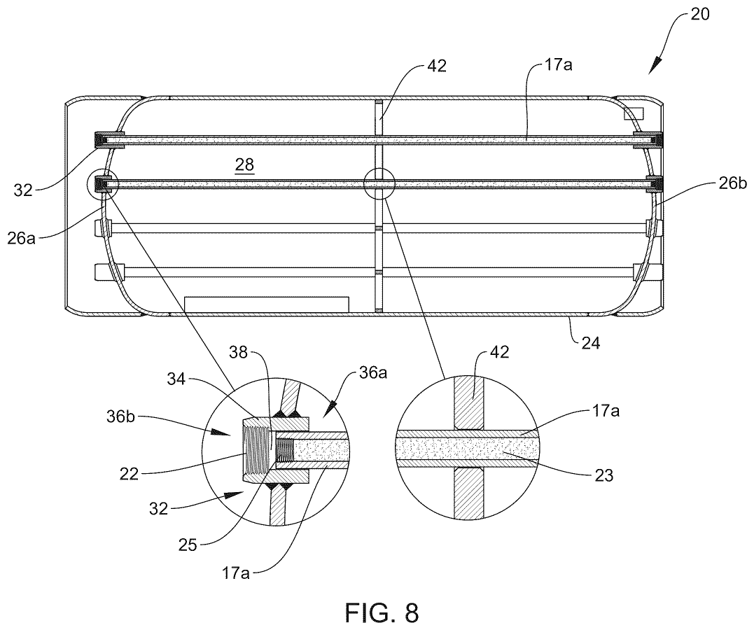

FIG. 8 shows a side cross sectional view of an embodiment of the fully assembled container 20 of FIG. 3 with poison rod tubes 17a containing a neutron absorbing material 23. The neutron absorbing material 23 is contained with each tube 17a via a closure 25, which can be welded in place (not shown), a male threaded plug (as shown) or a female threaded cap (not shown), situated at one or both ends of the container, depending upon the design.

As illustrated in FIG. 8, the container 20 has a cylindrical lateral wall 24 extending between concave first and second heads 26a, 26b to define a container interior 28 for receiving the radioactive material. The plurality of cylindrical poison rods 17a extend in parallel through the first end head 26a, through the container interior 28, through spacer plate 42, and through the second head 26b.

A plurality of access nozzles 32 are situated within the first head 26a and/or the second head 26b, but preferably both. Each of the access nozzles 32 has a lateral wall 34 defining a throughway that extends through the first head 26a between an interior end region 36a and an exterior end region 36b. The interior end region 36a captures and supports a respective end of a respective poison rod 17a. The exterior end region 36b defines a throughway that is larger in diameter than the interior end region 36a. The exterior end region being opened and closed via respectively detaching and attaching an end cap 22, such as a male threaded plug (as shown) or a female threaded cap (not shown), to thereby respectively expose and contain the respective poison rod 17a.

In the preferred embodiment, the pluralities of access nozzles 32 of the first and second heads 26a, 26b are aligned. Also, in regard to each of the access nozzle pluralities of the first and second heads 26a, 26b, the access nozzles 32 are situated symmetrically about a center.

In an alternative embodiment where the access nozzles 32 are placed on one but not both of the heads 26a, 26b, the heads without access nozzles 32 is equipped with a suitable support plate with apertures for securing and supporting the ends of the poison rods 17. In this embodiment, the poison rods 17 can only be accessed from one end of the container 20, i.e., the end having the access nozzles 32.

Each of the access nozzles 32 has an open throughway space 38 between the end cap 22 and the respective end of the respective poison rod 17a to enable the respective poison rod 17a to extend and retract along its longitudinal axis as its temperature fluctuates.

In the preferred embodiment, each of the access nozzles 32 extends at least one inch beyond an exterior of the concave first and second heads 26a, 26b to allow for attachment of heating and cooling elements.

A spacer plate 42 is situated within the enclosure between the first and second heads. The spacer plate 42 has a plurality of circular apertures. Each of the poison rods 17a passes through and is supported by the spacer plate 42 at a respective aperture at a midsection of the respective poison rod 17a.

Another embodiment of the fully assembled container 20 of FIG. 3 has poison rods 17 that are a solid neutron absorber. In this embodiment, there remains a space 38 between each solid poison rod 17 and its respective plug 22 to accommodate temperature fluctuations. Furthermore, the solid neutron absorber can be accessed just as the rod 17a is accessed.

Another embodiment, among others, is a method for storing and/or transporting HF6, which can be summarized by the following steps: providing a container 20 containing the HF6; detaching an end cap 22 of at least one of the access nozzles 32 to expose a respective poison rod 17 (or 17a); removing the respective poison rod 17; inserting a new poison rod 17 into the container 20 to replace the respective poison rod 17 by way of the respective access nozzle 32; and attaching the end cap 22 to the at least one access nozzle 32 in order to contain the new poison rod 17.

Finally, it should be emphasized that the above-described embodiments of the present invention are merely a possible nonlimiting example of implementations, merely set forth for a clear understanding of the principles of the invention. Many variations and modifications may be made to the above-described embodiments without departing substantially from the spirit and principles of the invention. All such modifications and variations are intended to be included herein within the scope of this disclosure and the present invention.

At least the following is claimed:

1. A container for storing radioactive material, the container comprising:
a lateral wall extending between concave first and second heads to define a container interior for receiving the radioactive material;
a plurality of cylindrical poison rods extending in parallel through the container interior, each of the poison rods having a neutron absorber; and
a plurality of access nozzles situated within the first head, each of the access nozzles having a lateral wall defining a throughway that extends through the first head between an interior end region and an exterior end region, the interior end region capturing and supporting a respective end of a respective poison rod, the exterior end region being opened and closed via respectively detaching and attaching an end cap closure to thereby respectively expose and contain the respective poison rod.

2. The container of claim 1, wherein in each access nozzle, the exterior end region defines a throughway that is larger in diameter than the interior end region.

3. The container of claim 1, wherein each of the access nozzles has an open throughway space between the end cap and the respective end of the respective poison rod to enable the respective poison rod to extend and retract along its longitudinal axis as its temperature fluctuates.

4. The container of claim 1, further comprising a second plurality of access nozzles situated within the second head, each of the access nozzles having a lateral wall defining a throughway that extends through the second head between an interior end region and an exterior end region, the interior end region capturing and supporting a respective end of a respective poison rod, the exterior end region being openable and closable via an end cap to respectively expose and contain the respective poison rod.

5. The container of claim 4, wherein the pluralities of access nozzles of the first and second heads are aligned.

6. The container of claim 5, wherein in regard to each of the access nozzle pluralities of the first and second heads, the access nozzles are situated symmetrically about a center.

7. The container of claim 1, further comprising the radioactive material.

8. The container of claim 7, wherein the radioactive material is uranium hexafluoride (HF6) having a concentration of fissile isotope uranium-235 (U-235) between 5% and 20%.

9. The container of claim 1, wherein each of the poison rods is a solid neutron absorber.

10. The container of claim 1, wherein each of the poison rods is a tube containing a neutron absorbing material.

11. The container of claim 1, further comprising a spacer plate situated within the enclosure between the first and second heads, the spacer plate having a plurality of circular apertures, and wherein each of the poison rods passes through and is supported by the spacer plate at a respective aperture at a midsection of the respective poison rod.

12. The container of claim 1, wherein each of the access nozzles extends at least one inch beyond an exterior of the concave first and second heads to allow for attachment of heating and cooling elements.

13. The container of claim 1, wherein the end cap is a plug or cap.

14. A method for storing radioactive uranium hexafluoride (HF6), the method comprising the steps of:
providing the container of claim 1 containing the HF6;
detaching an end cap of at least one of the access nozzles to expose a respective poison rod;
removing the respective poison rod;
inserting a new poison rod into the container to replace the respective poison rod by way of the respective access nozzle; and
attaching the end cap to the at least one access nozzle in order to contain the new poison rod.

15. The method of claim 14, further comprising the steps of:
removing the HF6 prior to detaching the end cap;
reintroducing HF6 to the container after inserting the new poison rod and attaching the end cap.

16. A container for storing radioactive material, the container comprising:
a lateral wall extending between concave first and second heads to define a container interior for receiving the radioactive material;
a plurality of cylindrical poison rods extending in parallel through the first head, through the container interior, and through the second head, each of the poison rods having a neutron absorber; and
means associated with one or both of the heads for permitting removal and insertion of each of the poison rods via respectively detachment and attachment of an end cap.

17. The container of claim 15, further comprising a means for permitting each of the poison rods to extend and retract due to temperature changes.

18. The container of claim 15, further comprising the radioactive material in the form of uranium hexafluoride (HF6) having a concentration of fissile isotope uranium-235 (U-235) between 5% and 20%.

19. The container of claim 15, wherein the closure is a female threaded end cap or male threaded end plug.
